(19) United States
(12) Patent Application Publication
(10) Pub. No.: US 2025/0252812 A1
(43) Pub. Date: Aug. 7, 2025

(54) Gaming System Utilizing Indicators

(71) Applicant: Genesis Gaming Solutions, Inc., Spring, TX (US)

(72) Inventor: Olaf Vancura, Las Vegas, NV (US)

(73) Assignee: Genesis Gaming Solutions, Inc., Las Vegas, NV (US)

(21) Appl. No.: 19/046,416

(22) Filed: Feb. 5, 2025

Related U.S. Application Data
(60) Provisional application No. 63/549,728, filed on Feb. 5, 2024.

(51) Int. Cl. G07F 17/32

(52) U.S. Cl. CPC G07F 17/323

(57) ABSTRACT

The various embodiments generally pertain to a gaming system and method of providing an indicator game by displaying a plurality of potential indicators, each of which indicates a percentage of success and an associated award. By way of one example, upon the player selecting one of the indicators, a selected indicator game is implemented resulting in a game outcome or outcomes, and the player is awarded the associated award(s).

### FIELD

The present disclosure relates to a gaming system and method of gaming utilizing indicators in a gaming environment.

### BACKGROUND

Play on electronic gaming machines (EGMs) or gaming devices is typically begun via placement of a wager by a player, from the player's current monetary (or credit) balance. Such a wager typically initiates a base (or primary) game. Base games may comprise various game types including typical slot machine play (for example, the spinning of multiple reels of symbols), video poker play (the dealing of cards), keno play (the “drawing” of numbered balls) or a representation of table games play (spinning a roulette ball, rolling dice for craps, dealing cards for blackjack, etc.). For traditional slots, awards may be based upon symbol combinations compared to a paytable. Similarly, in video poker awards are determined via a final card combination compared to a paytable. In keno, the numbers drawn are compared to the player's scorecard. Particularly with slot machine games, players often root for bonus (or secondary) games, which typically require no additional wager but usually award the player an amount substantially in excess of the wager.

Gaming games are designed, in the long run, to return to players a designated percentage of all monies wagered (known as RTP which is short for “return to player”), the underlying calculations of which are shown on a Par sheet. Gaming games also use a random number generator (RNG) to ensure randomness and fairness. The generated random numbers are mapped onto, e.g., positions on a slot reel strip, cards in a deck, keno numbers, objects to be selected, etc. Crucially, the RNG, RTP and associated Par sheets ensure and describe the fairness of the games, and as such are highly regulated.

### BRIEF SUMMARY

In one embodiment a gaming system is described that implements an indicator game by displaying a plurality of potential indicators, each of which indicates a percentage of success and an associated award. Upon the player selecting one of the indicators, the selected indicator game (or a plurality thereof) is implemented resulting in a game outcome or outcomes, and the player is awarded the associated award(s).

Instructions cause at least one processor to implement the indicator game and accept a player input as to selection of one of the plurality of potential indicators. The instructions thereafter cause the at least one processor to implement one or more instances of the selected indicator. The instructions cause the at least one processor to determine if each of the one or more instances of the selected indicator was successful. The instructions cause the at least one processor to determine at least one associated award if a selected indicator play was determined to be successful.

A method of gaming is described wherein the wager initiates an indicator game by displaying a plurality of potential indicators, each of which indicates a percentage of success and an associated award. The method offers the player a selection of one of the potential indicators. The method, based upon player selection input, implements the player-selected indicator game (or a plurality thereof). The method determines if each play was successful and awards associated awards.

The processor is configured to perform various operations including initiating an indicator game, causing the display of a plurality of potential indicators each with a probability of success and associated award, receiving input from the player as to a selected potential indicator, implementing one or more instances of the selected potential indicator, determining whether the indicator(s) had a successful outcome, and awarding successful plays.

In one embodiment a gaming system is described that implements an initial indicator game, with the initial indicator indicating a percentage of success and an associated number of secondary plays. When the initial indicator game is successful, the player is awarded the associated number of secondary plays, each of which comprises an indicator with a percentage of success and associated award.

Instructions cause at least one processor to implement the initial indicator game and determine whether the initial indicator game was successful. The instructions cause the processor to implement an associated number of secondary plays, each with an indicator comprising a percentage of success and associated award, if the initial indicator game was determined to be successful. The instructions cause the processor to determine if each individual secondary play was successful. The instructions cause the processor to determine one or more associated awards if one or more secondary plays was determined to be successful.

A method of gaming is described wherein the wager initiates an initial indicator game, which indicates a percentage of success and an associated number of secondary plays. The method, based upon the displayed indicator game outcome, determines if the player is successful. If so, the player is awarded the associated number of plays of secondary indicators. In the method, these plays of secondary indicators each indicate a percentage of success and an associated award. Upon implementing the secondary indicators, the method determines which secondary indicators resulted in success and, in turn, awards the associated award(s).

The processor is configured to perform various operations including initiating an indicator game, determining whether the indicator game had a successful outcome, initiating one or more secondary indicator plays, determining whether the secondary indicator plays had successful outcomes, and awarding successful secondary plays.

### BRIEF DESCRIPTION OF THE FIGURES

FIG. 1 illustrates an embodiment of a gaming device for implementing aspects of game play.

FIG. 2 illustrates a schematic view of one embodiment of the components associated with the gaming device of FIG. 1.

FIG. 3 illustrates one embodiment of the environment for implementing the social gaming aspect of the game play.

FIGS. 4A-4J illustrate several examples of indicators.

FIG. 5 shows a flowchart of a process or method of operating one example embodiment of the gaming system of the present disclosure to provide a play of one example embodiment of the wagering game.

FIG. 6 shows a flowchart of a process or method of operating one example embodiment of the gaming system of the present disclosure to provide a play of one example embodiment of the wagering game.

FIG. 7 illustrates a portion of a representative probability table for an example wager of 25 units in accordance with one embodiment of the illustrated invention.

FIG. 8 illustrates a portion of a representative probability table for an example wager of 30 units in accordance with one embodiment of the illustrated invention.

### DESCRIPTION OF GAMING SYSTEM

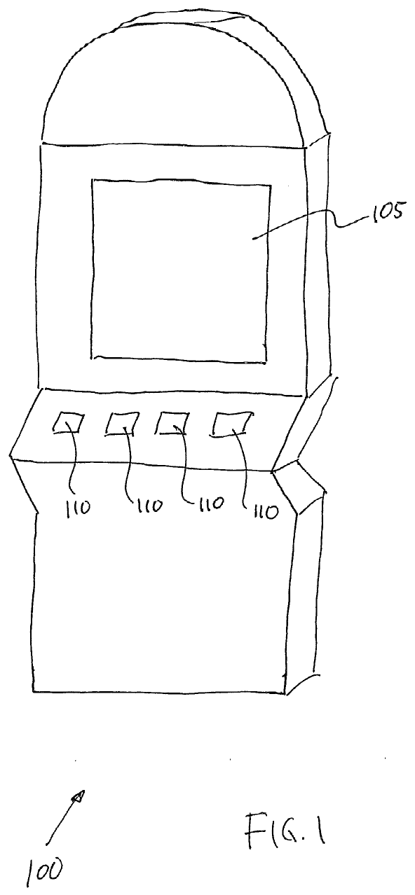

As shown in FIGS. 1-3, an electronic gaming system is described that comprises a gaming controller and a display, said gaming controller comprising a processor 112 and a memory device 114 that stores a plurality of instructions, that when executed by processor 112, causes processor 112 to conduct the described method of play illustrated and described herein.

As used herein, “gaming system” may refer to configurations of (a) one or more game servers, controllers or remote hosts, (b) one or more electronic gaming machines (EGMs) which, for example, may be located in a casino, and/or (c) one or more remote gaming devices including, but not limited to, a smart phone, tablet, desktop, laptop or computing device, in communication with a game server. The present invention contemplates a variety of gaming systems with a plurality of different features.

As used herein an EGM may refer to any suitable electronic gaming machine which enables a player to wager upon and play a game (regardless of the degree of chance or skill involved) to potentially win one or more awards. Examples of an EGM include but are not limited to a slot machine, video poker machine, video keno machine, video blackjack machine, video lottery terminal, sports betting terminal and electronic table game terminal.

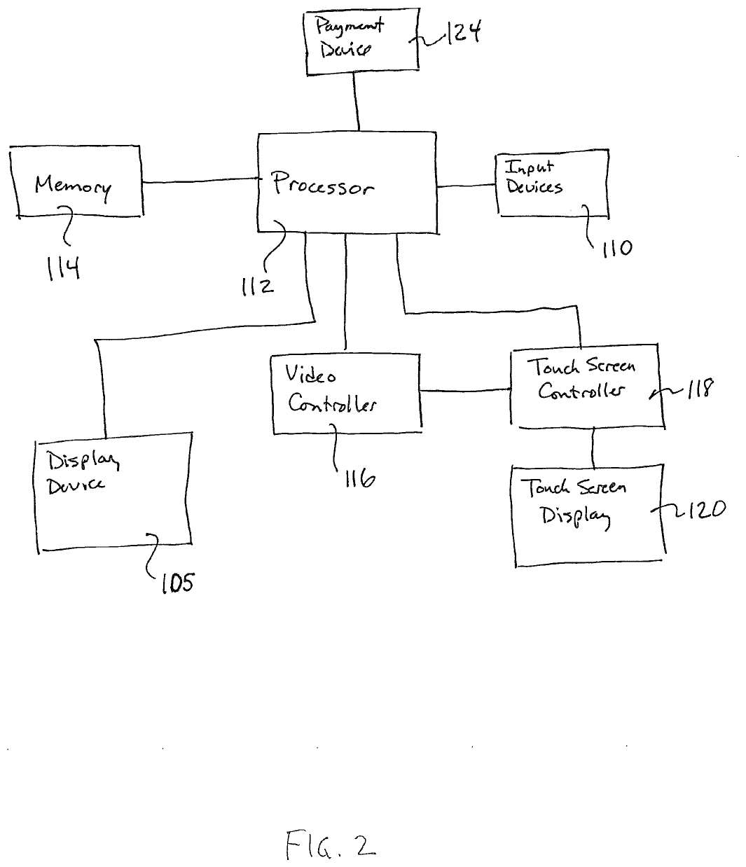

As shown in FIG. 2, at least one processor 112, at least one memory device 114, and display 105 are operably connected. The at least one memory device 114 stores computer-readable instructions for controlling the at least one processor 112 to implement the described method of play. In some embodiments, the plurality of instructions, when executed by processor 112 further causes the processor to communicate data that results in a display, by the display device 105. In some embodiments the processor 112 is configured to control the display device 105 either directly or indirectly through a video controller 116 (e.g., through an integrated GPU or dedicated graphics card with VRAM). In some embodiments, processor 112 is configured to receive a player input, via an input device 110 (for example via touchscreen controller and display 118, 120 or buttons), e.g., corresponding to a wager or to the playing of a game.

An indicator, as used herein, indicates a depiction of a player's chance of success to win an award. An award may be in cash, credits, plays of indicators, bonuses or features, free games, free tickets, etc. Generally, an award is anything of value. Upon implementation, the indicator indicates an outcome, for example of success or failure.

In the embodiments illustrated in FIG. 1, gaming device 100 has a support structure, housing, or cabinet which provides support for a display 105, inputs 110, controls, and other features of a conventional gaming machine. It is configured so that a player can operate it while standing or sitting. The gaming device can be positioned on a base or stand or can be configured as a pub-style table-top game (not shown) which a player can operate preferably while sitting. As illustrated by the different configurations shown in FIG. 1, the gaming device may have varying cabinet and display configurations.

Gaming devices, including EGMs, come in various configurations and may be networked to various gaming related servers. One embodiment may be configured to work as part of a gaming system including one or more server computers. Another embodiment may be configured to be played at an EGM wherein the RNG and instructions are stored and run on the EGM. In such an embodiment applied to an EGM, the software to run the illustrated embodiment of the invention described herein may be installed and loaded directly within the EGM or downloaded by the EGM from a game server.

As shown in FIG. 1, an EGM often utilizes a cabinet design and is positioned on a casino floor. Gaming devices may include one or more displays and house a mechanical apparatus (such as a wheel or pachinko playfield, etc.). An EGM cabinet may also internally house, operably connected to the game controller, for example via one or more device drivers, one or more of a primary display, secondary display, card-reader, slot-machine interface board (SMIB), player-tracking display, ticket printer, ticket reader, bill validator (BV), touch-screen input, input button(s), button display, cabinet lighting, speaker(s), cabinet security sensors and internal CPU box sensors. Other hardware and/or drivers may be operably connected to the game controller.

In some embodiments, a gaming device is included in a gaming system that may include one or more external servers (for example, a casino player tracking server, a ticket-in-ticket out server, a progressive system server or controller, a casino management system server, a central or game server, etc.) operably connected to the gaming device. The gaming devices may afford players and operators the opportunity to utilize functionality implemented on and/or display data located on one or more of the servers.

Memory 114 for the gaming device(s) and/or server(s) may comprise RAM, storage media, non-volatile memory, one or more EPROMs, EEPROMs, hard drives, solid state drives, flash memory, one-time programmable chips, OptionROM, BIOS, etc. It may also include memory utilizing battery-backup or other non-volatile memory as may be required by gaming regulations.

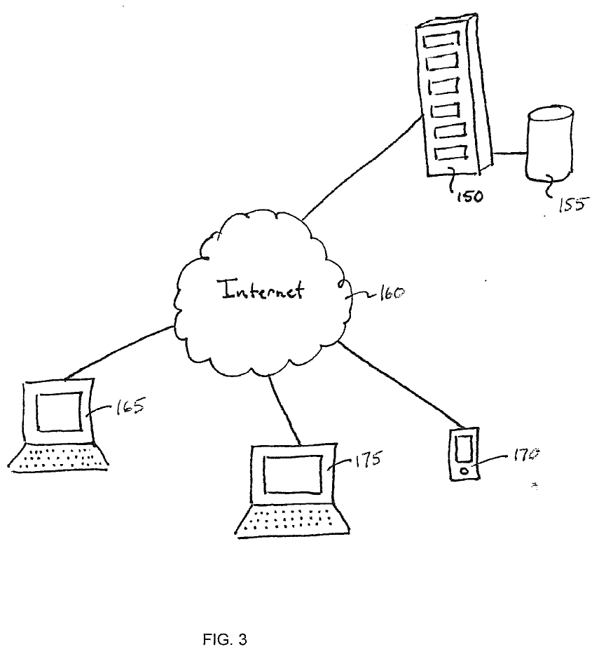

In another embodiment, the gaming system illustrated and described herein may be configured to be played remotely, with the RNG and instructions stored and run on a game server computer in communication, directly or indirectly e.g. through one or more other servers, with a player's gaming device. In some embodiments as illustrated in FIG. 3, a player's gaming device may communicate with the game server over the Internet, intranet, a private network, a wireless network, etc. or a combination thereof. The game server and player's gaming device may be housed in the same location, or they may be geographically separated. In some embodiments, the player must log-in (e.g., via username, password, two-factor authentication, biometric credentials, etc.) to or through the gaming system in order to initiate wagering. In some embodiments, the communication between a player's gaming device and game server may be encrypted. In some embodiments, the gaming system comprises a gaming device, that may be an EGM and/or a remote gaming device including, but not limited to, a smart phone, tablet, desktop, laptop or computing device, in communication with a game server. Such a gaming system may furthermore include communications between the game server and one or more of a controlling server, accounting server, history server. Game outcomes may be generated on a game server and transmitted, directly or indirectly, via a network, to one or more remote gaming devices, terminals, EGMs, etc. which display results to players. The player's device, as client, may utilize encrypted communication with the game server in a “thin client” configuration via the world wide web. The player's device may utilize geolocation data in conjunction with device geolocation functionality to determine geographic location and transmit this information to one or more servers to verify the player is within a defined regulated jurisdictional area. The player's device may utilize a rechargeable power source, such as a rechargeable battery.

In some embodiments in which the gaming system includes a gaming device in combination with a central game server (or controller or remote host), the server is a suitable computing device comprising at least one processor and at least one memory or data storage device. In such embodiments, each of the server and gaming device processor is configured to execute, transmit and receive data, or cause the same thereof, representing events, commands and gaming system and/or game related information. A subset of functions of the server may be conducted by the gaming device, and vice versa. Instructions for controlling the games displayed by the gaming device may be executed by the server in a “thin client” arrangement, such that the server remotely controls the games as displayed on the gaming device, and the gaming device in turn receives player input which is transmitted back to the server. Alternately, in a “thick client” arrangement, the gaming device executes the instructions locally.

Gaming systems and/or devices, capable of awarding monetary value, are highly regulated to assure fairness for both the player and the operator. To satisfy the requirements of a regulated gaming environment, specialized hardware and/or software is implemented in gaming devices and/or gaming servers that markedly differs from general purpose computers. Within a gaming system, specialized hardware and/or software exists to adhere to strict regulations. For example, utilizing one or more general purpose computers is not suitable for use in a gaming system. Furthermore, it is not trivial to adapt such general purpose equipment for gaming use. This is due to a) regulatory requirements for gaming systems, b) strenuous ambient conditions of operation, c) verification and security regulations, d) game recovery and fault tolerance regulations, and/or e) specialized hardware and software. Substantial, complex development beyond a general purpose computer is required to meet gaming regulations.

For example, with respect to hardware and software, the components which run the game engine (that is, implement the software instructions including an RNG and underlying math in order to execute the algorithms, according to the game rules, to generate game outcomes) are subject to considerable regulatory scrutiny. In a gaming system in an online gaming environment, the engine may be executed on the game server (e.g., a thin client embodiment). In a gaming system within a brick-and-mortar casino, the engine may be executed on the EGM (e.g., a thick client embodiment).

The hardware and/or software within a gaming system, including that running the game engine, must adhere to regulatory requirements. For example, regulations require a secure-boot via a chain-of-trust, to ensure no unapproved hardware or software is present. This may occur, e.g., via a hash algorithm such as SHA-1 first generating a BIOS value from the BIOS chip and verifying this value by comparison to a regulatorily submitted and verified value stored on a one-time programmable ROM chip, and next, via a hash algorithm generating a hard drive/SSD value for each associated file and verifying these values by comparison to regulatorily submitted and verified values stored on the one-time programmable ROM chip, checking via hash subsequent hardware firmware/drivers, etc. Via this sequence, it is confirmed that no unverified hardware and/or software is ever initiated. In this manner the software running the game engine is static and unchangeable, with any modifications requiring further regulatory approval. Furthermore, the processor may continuously monitor all running processes and compare to a “whitelist” of approved (authorized) processes, locking down the system in the case of an unauthorized process. The hardware and software function as a state machine, able to return to any previous state, either upon reboot, power interruption or system failure. The game system must be able to recover a prescribed number (e.g., 10 or 50) of last game plays, including any features or bonuses that may have been triggered. In so doing, the processor must save (to non-volatile memory) all necessary attributes of each game result, and must verify (e.g., via a CRC-16 algorithm) data integrity of previously played games. An EGM may need to be able to withstand a prescribed voltage shock, with (depending on voltage) either no effect or a reboot of the device with return to the previous state. The gaming system may need to withstand repeated power cycling. Indeed, many faults tolerated in a general computing device, such as software bugs that lead to a device hanging or crashing, hardware failures, overheating, etc., are not acceptable in an EGM either due to regulatory rules or, from a business perspective, the ensuing loss of revenue. Many conveniences, such as installing new software, updating software, reading from a USB drive, facilitating device connectivity, etc., which are the norm on a general computing device, may also be forbidden in the regulated environment, due to the required strict ongoing security scrutiny of hardware, software and CPU processes. Furthermore, an EGM CPU must communicate with peripheral devices and/or features that are not found on general purpose computers, including for example, bill validators, ticket readers/printers, SMIB boards, cabinet lighting, topbox controller, etc. Furthermore, the gaming system provides for gaming regulators, at any time and unannounced, to have the ability to access and inspect the system and also run independent checks (such as on-the-fly hash function verification) that only submitted and approved hardware and/or software is implemented. These are examples of attributes and features that may be found in the present gaming system but not found on general purpose computers.

Various functional components are implemented by the game controller. Functional components may include the utilization of data stored in memory, including data indicative of denomination amounts and possible wager levels, data indicative of indicators, data defining characteristics of an initial (or base) game, data indicative of probabilities of success in the initial game, data indicative of awards in the initial game, data indicative of characteristics of secondary games, including win probabilities and awards for the secondary games, data indicative of game configuration, data indicative of characteristics of bonus games and data indicative of one or more jackpots including, for example, reset value, increment and current value.

Furthermore, to conduct the game play, functional components also include, for example, an initial indicator instantiater which generates the probability of success using the random number generator and potential award using the random number generator, and an initial indicator implementer which causes the display and animation of an initial indicator to an outcome using the random number generator. An outcome evaluator determines if the initial indicator was successful, and an award determiner determines the amount to award.

In one embodiment in which the initial indicator yields a number of plays of secondary indicators, functional components furthermore conduct this secondary game play, including each play's instantiater which determines a probability of success using a random number generator and potential award using a random number generator, and secondary indicator implementer causing the display and animation of a secondary indicator to an outcome using a random number generator. An outcome evaluator is also utilized for each secondary indicator.

In another embodiment where one or more bonus games is offered and triggered through play of the initial or secondary games, functional components for evaluating a triggering condition, initiating the bonus, initiating a number of free plays, evaluating the outcome of a free play, etc. may be implemented by the game controller.

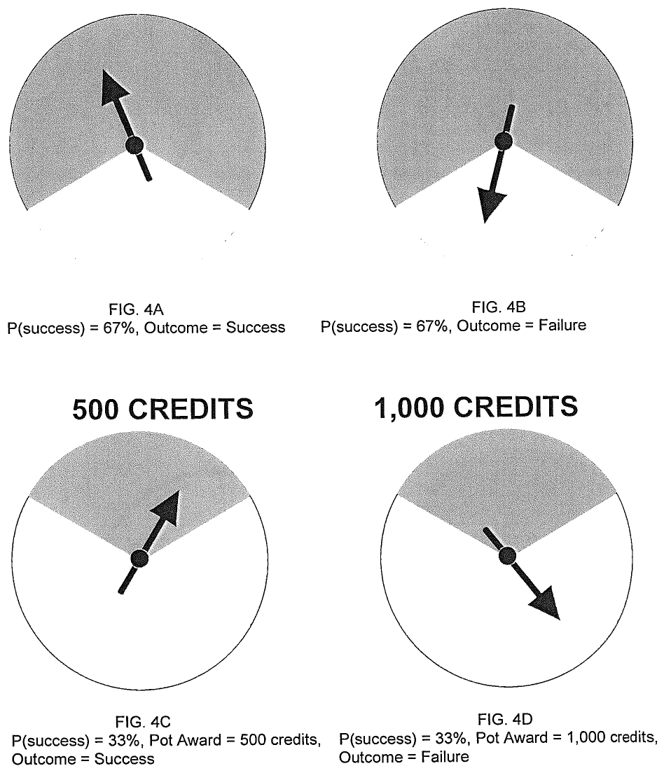

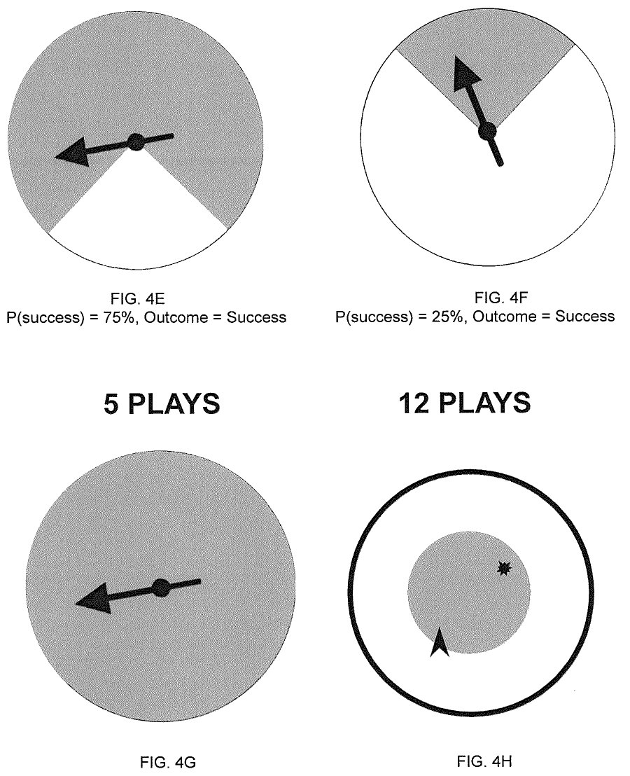

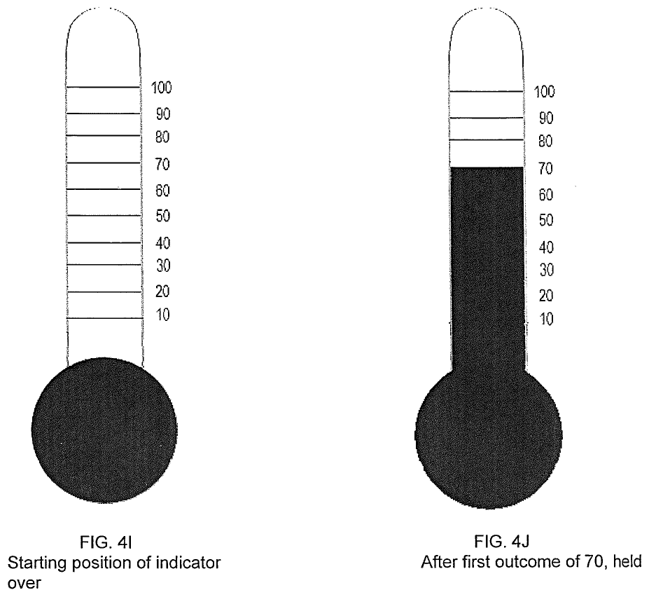

FIGS. 4A-4J illustrate several examples of indicators. In one embodiment, the indicator visually represents a probability of success and a probability of failure, with the sum of these two probabilities equal to 1. In a preferred embodiment, for example as shown in FIGS. 4A-4J, importantly the visually displayed probabilities of success (and failure) accurately portray the underlying mathematical probabilities of success (and failure). In another embodiment, the displayed probabilities do not represent the underlying probabilities.

In FIGS. 4A-4H, success is depicted as the shaded area, while failure is depicted as white. Of course, other colors and/or visual effects may be utilized, such as animations, glows, watermarks, etc. to aid the player's understanding or increase a player's excitement during play. During implementation of the indicator, in a preferred embodiment the spinner spins and decelerates, eventually coming to a stop in either the shaded or white areas. This may be accompanied by visual and/or audio effects. Alternate forms of spinning are possible, including coming to an abrupt stop, accelerating until stopping, spinning until the pointer “breaks,” etc.

FIGS. 4A-4H also depict the final positions of spinners which indicate success or failure. In one embodiment, the final stopping position of a spinner is equally likely in any angular position, i.e. a fair spinner. In one embodiment, the spinner may only stop at preset angular positions (which may number, e.g., 360 or 100 preset available positions, and so forth). In one embodiment, the final stopping position of a spinner may be weighted such that some angular stopping positions are more likely than others.

In FIG. 4A, the probability of success is 67%, and the outcome of the spin is success. In FIG. 4B, the probability of success is 67%, and the outcome of the spin is failure. In FIG. 4C, the probability of success is 33%, and the indicator's outcome is success. In FIG. 4D, the probability of success is 33%, and the outcome is failure. In FIG. 4E, the probability of success is 75%, and the outcome is success. In FIG. 4F, the probability of success is 25%, and the outcome is success. In FIG. 4G, the probability of success is 100%, and the spinner's outcome is success. In FIG. 4H, the indicator is depicted as a target, with an approximate 25% probability of success, and an arrowhead or bullet-hole type of indicator indicating success.

Various indicators are possible under the teachings herein. For example, instead of a fixed circular area with an animated pointer as depicted in FIG. 4A-4H, a fixed pointer (for example, located at the 12 o'clock position) may be utilized with an animated wheel. As the wheel stops, a pointer pointing to shaded or white depicts success or failure. Or, a circular target area may be shown, with the probability of success represented as a “bullseye” circular area in the central part of the target, for example as in FIG. 4H. An arrow may then appear on, or animate onto, the target and the arrow's target location (either within the bullseye or not) depicting success or failure.

In one example, an indicator depicting a carnival-type show-of-strength, a sledgehammer striking a see-saw to catapult an object upward in order to “hit the bell,” may be shown. The bell may be shown atop a rectangular area with demarcations showing a range of 0 to 100 units of height. A particular target of 35 may be highlighted, depicting that this is the threshold for success. If each of the numbers in the range 1 through 100 is equally likely through implementation of the RNG, then random numbers 1 through 34 correspond to failure, while random numbers 35 through 100 correspond to success. Via animation, the object is launched upward to a peak height as selected by the RNG, depicting either success or failure to the player.

In some embodiments, the indicator is reset prior to the next wager or play. For example, the indicator may be reset to a “home” or “starting” position, and its probability of success and/or award may be re-randomized for the next wager. In one embodiment, only one of probability of success or award is re-randomized. In one embodiment, the indicator's probability of success and award remain the same until a play results in success.

Furthermore, in one embodiment, the player may have multiple attempts to experience success with an indicator, with each failed attempt increasing the chance of success for the next. For example, in the “hit the bell” embodiment, the player, if not reaching the threshold for success, may be allowed to continue to build upon the previous level attained. For example, if the target for success is 90, and the player's first play resulted in a peak height of 40, the next play may continue from the previous level of 40, leaving only 50 units of height now required for success. A similar approach may be taken with a depiction of a thermometer, for example, and a burst of flame underneath leading to an increase in temperature (see FIGS. 4I and 4J, which shows a first level of 70, out of 100 needed for success, held over for a next play). Or a speedometer-type indicator may be shown with the goal to get to 125 mph. Each play may result in a “vroom” visual and/or sound effect with the displayed elements jittering, and an increase in the speed displayed from the previous play's level, until success is achieved. In one embodiment, the play level is held over as constant between plays, whereas in one embodiment the play level declines slowly with time, so as to indicate a decay, between plays. Note that in one embodiment, the player may be able to succeed in one play. In another embodiment, it may always require at least two, or a number greater than one, plays to succeed. In one embodiment, the range of numbers possible may vary from game to game or play to play. For example, the range of possible numbers may be a function of proximity to the target. The range may be a function of wager, for example a wager of $0.50 yields a possible range of 0 to 50, while a wager of $1.00 yields a possible range of 0 to 100, etc. Or the probability of success may scale with wager. For example, a wager of $0.50 may yield a probability of success equal to half that for a wager of $1.00 for the same potential award, etc. Or a wager of $0.50 may yield a probability of success less than half, such as 48%, compared to a wager of $1.00 for the same potential award. In one embodiment, a lesser wager has the same probability of success but plays for a correspondingly lesser amount. So for example, a wager of $0.50 may have an indicator with a 30% chance of winning 100 credits, while had the wager been $1.00, the indicator would have indicated a 30% chance of winning 200 credits.

Note that award values are not shown in FIGS. 4A-4H but may be displayed adjacent to, superimposed on top of, or otherwise depicted as associated with an indicator. In an embodiment where multiple indicators all have the same award, the award may be positioned in a “headline” capacity above the multiple indicators.

Note also that an indicator may comprise more than one award and/or more than one probability of success. For example, an indicator may include an award for 100 credits with a 50% probability of success and a second award for 10,000 credits with a 1% probability of success, for an overall probability of success of 51%.

Furthermore, the attributes of the indicator, such as size, colors, artwork, design, animation, etc. may be differentiated to draw attention to and highlight particular awards (such as large awards, large awards relative to the wager, bonus games, features, free plays, etc.) that may be won. Similarly, attributes of an indicator may be differentiated to highlight particular probabilities of success (such as large probabilities of success, etc.).

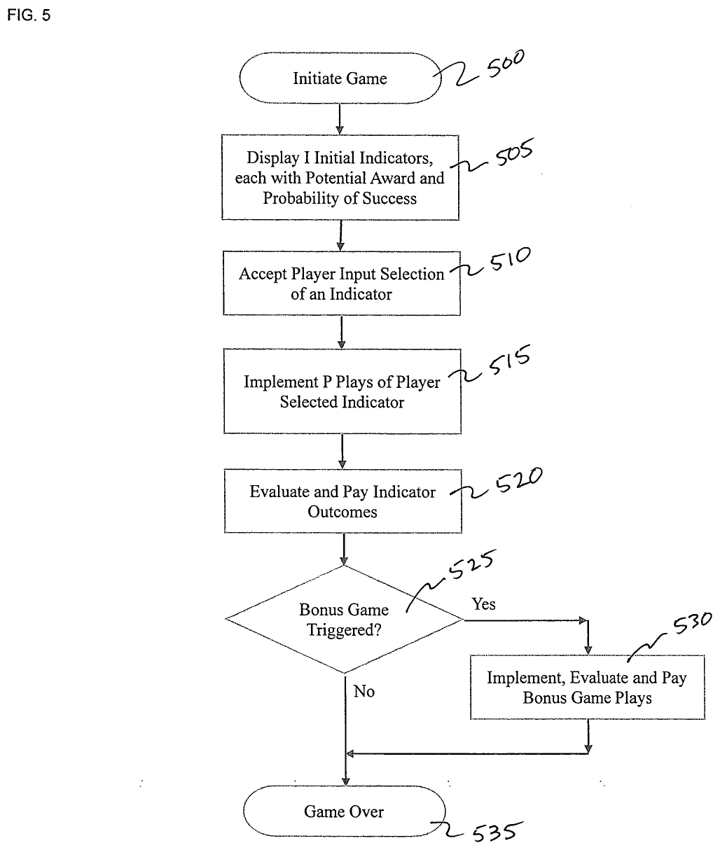

In an embodiment, shown as a flowchart in FIG. 5, as shown at 505, the player is presented with a plurality of initial indicators, with each indicator indicating a probability of success and award amount. For example, two indicators, the first indicating a 30% chance of winning 300 credits and the second indicating a 10% chance of winning 900 credits, are randomly chosen, based on the probability and award tables and utilizing an RNG, and presented to the player. The player is prompted to choose one of the indicators. As shown in 510, the player selected indicator is then played, under control of the processor and utilizing the RNG to determine if the play is successful or not. AS shown in 520, if successful, the player is awarded the associated award. Note that the probabilities of success need not be 30% and 10% but may in principle be any probabilities greater than 0% up to and including 100%. They may vary from game to game. For example, the initial indicators may indicate (1) a 20% chance of winning 600 credits and (2) a 100% chance of winning 100 credits.

In one embodiment, more than two initial indicators may be utilized from which the player chooses. This may be a fixed number, e.g. 3, for each game, or it may vary randomly from game to game.

Furthermore, the chosen indicator may be instantiated and played more than once. This may be a fixed number, e.g. 5, for each game, or it may also vary randomly from game to game.

Generally, the player may choose from “I” initial indicators, and the chosen indicator may be instantiated (and played) P times. For example, a player may be shown 3 initial indicators (I=3) depicting (1) a 10% chance of winning 1,000 credits, (2) a 25% chance of winning 400 credits and (3) a 90% chance of winning 100 credits. The player is prompted to choose one of the indicators, which in turn is replicated to create 5 instances (P=5) of the chosen indicator, each of which is then played to an outcome, under control of the processor and utilizing the RNG to determine if the play is successful or not. The player is awarded the total of all successful plays. For example, if the player chose the indicator associated with a 25% chance of winning 400 credits, and won (i.e., was successful in) 2 of the 5 ensuing instances of the chosen indicator (losing the other 3 plays), the player would be awarded 800 credits.

In an embodiment, only one initial indicator may be utilized, and the player does not choose from a plurality of initial indicators.

In an embodiment, the play of a plurality of instances of an indicator (e.g., of the player's chosen indicator) may be played simultaneously, sequentially, or with offset with respect to starting and/or ending times (e.g., each ending is offset by 0.25 or 0.5 seconds from left-to-right, top-to-bottom, across, etc. so as to let the player see the outcome of each indicator rapidly in succession). In one embodiment, each indicator may start simultaneously but have different times to animate and display the outcome of success/failure, such that the player may see the outcome of each indicator slightly offset rapidly in succession. Other variations are possible, for example, highlighting the indicators with the highest potential wins and/or reserving these outcomes to finish animating last.

In one embodiment, each of the initial indicators' chance of success and award values are randomly drawn, via an RNG, from a table of probabilities and awards stored in memory. In another embodiment, one indicator's chance of success and award values are randomly drawn from a table of probabilities and awards as stored in memory, and other indicators' chance of success and award values are then dynamically calculated. For example, if a first initial indicator is randomly determined to be 30% chance of winning 400 credits, the processor may dynamically determine a second initial indicator to be twice the chance (i.e., 60% chance of winning) for half the award (i.e., 200 credits). The two initial indicators presented to the player would then be (1) 30% chance of winning 400 credits and (2) 60% chance of winning 200 credits. Alternatively, the processor may dynamically determine the second indicator to be half the chance for twice the award. In this case, the second initial indicator would be a 15% chance of winning 800 credits. Other algorithms may be suitably utilized in such a dynamic approach to creating the initial indicators, e.g. triple and ⅓, quadruple and ¼, etc. One such algorithm may evaluate the first indicator's chance of success and award, determine its chance of success relative to a 50% midway mark, and create a second indicator to complement the first. That is, if the first indicator's chance of success is less than 50%, then the processor dynamically creates a second indicator with chance of success at least equal to 50%, and vice-versa. For example, if a first indicator is determined to be 10% chance of 5,000 credits, the processor may dynamically create a second indicator to be 80% chance of 625 credits. One such algorithm may evaluate the first indicator's potential award, and depending on the award value, create a second indicator with substantially higher value. For example, if the first indicator's value is 10 credits, the processor dynamically creates a second indicator's value of 100 credits, for example with a correspondingly lower probability of success.

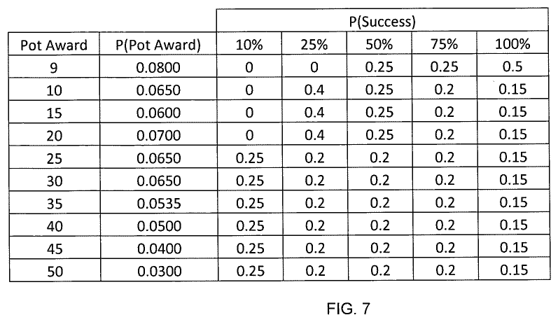

In FIG. 7, a portion of a representative probability table is shown, for a wager of 25 units. A first indicator's potential award (as shown in column 1) has a probability (as shown in column 2) of being randomly selected. For example, 40 credits have a 5% chance of being randomly selected as the potential award. Furthermore, the indicator's probability of success is also randomly selected after selecting the potential award. For 40 credits as the potential award, the P(success) for the indicator has a 25% chance of being 10%, a 20% chance of being 25%, a 20% chance of being 50%, a 20% chance of being 75% and a 15% of being 100%. So once the potential award is selected, utilizing an RNG via a weighted probability table, the corresponding P(success) value is selected, utilizing an RNG via a weighted probability table associated with the potential award. So, for example, for a first indicator potential award of 40 credits, there is a 15% chance that P(success) will equal 100%, as may be depicted in FIG. 4G. Utilizing the dynamic algorithm described earlier, a second indicator may depict twice the award for half the P(success), i.e. a second indicator presented to the player may depict a potential award of 80 credits with a probability of success equal to 50%. Alternatively, a second indicator may depict a potential award of 160 credits with P(success)=25%, 200 credits with P(success)=20%, etc., and in these examples the expected value remains constant for the second indicator, so the player's risk tolerance is accommodated with varying volatilities among the choices. However, this constant expected value need not be so. A second indicator may be chosen with a slightly lesser expected value, such that decision-making (or strategy) is introduced for the player to maximize expected value. For example, dynamically a second indicator may be calculated and depict a potential award of 155 credits with P(success)=25% once the initial indicator is determined. Presented with a choice of a first indicator indicating a 100% chance of winning 40 credits and a second indicator indicating a 25% chance of winning 155 credits, the player in order to maximize expected value would need to choose the first indicator.

In one embodiment, one (or more than one) of the initial indicators comprises a trigger that has, as its award, a bonus game. That is, if the player chooses said indicator, and has a successful outcome, a bonus is awarded. The bonus may comprise a plurality of free plays of indicators. The free plays may include a number of indicator plays with or without player choice. In an embodiment in which the base game comprises the player choosing from among I indicators which yields P plays of the chosen indicator, the bonus game may instead yield PB plays of an indicator, with or without player choice, with PB greater than P. The bonus game may award plays of a primary and/or secondary indicator, or specially denoted indicators that differ from primary or secondary indicators. The bonus game may utilize enhanced multipliers, either external to the indicators which, for example, increase the value of one or more indicators, or as an attribute associated with an indicator which, when successful, for example multiplies wins of one or more other successful indicators or multiplies potential wins of as yet unplayed indicators. The bonus game may utilize specially denoted indicators, which award a feature or bonus award upon their success. For example, a specially denoted “supernova” indicator may, if successful, on a display send out a circular shock wave causing all other displayed indicators to double in value. Or, a specially denoted indicator with an “earthquake” award may nudge/shake neighboring (or all) indicators to be successful if not already so, and the game system therefore awards their awards. In an embodiment, the bonus game may retrigger (e.g., awarding additional free plays).

In one embodiment, the teachings herein may be utilized in a “hold and respin” method. Such a method may be particularly suited for a bonus game. For example, a plurality of indicators, each with a probability of success and associated award, may be utilized. Upon initiating the bonus, the player may be awarded a number S of initial spins beginning with a set of indicators, all of which are active (A active indicators). For each of the S spins, all active indicators are played to either success or failure. Any successful indicator pays the associated award, renders it inactive for future spins and resets the number of spins to S. Once all the spins are exhausted, or all indicators are successful, the game ends. One embodiment affords the player an additional S spins if no indicators are successful after the first S spins. In a variation of this embodiment, the player may be awarded a feature or bonus award (which may be a function of existing successful or unsuccessful indicators) for specially denoted indicators upon their success. For example, a specially denoted indicator, if successful, may award a “bomb” which in turn automatically awards neighboring indicators. A successful indicator may award a doubler (or tripler, etc.), such that successful, unsuccessful, some or all indicators' award values are doubled. In a variation of this embodiment, a subset of indicators may award jackpots, including progressive jackpots. In a variation of this embodiment, a subset of successful indicators may be removed and replaced with new indicators, such that the number of active indicators A may not only decrease but also increase. This may be through successfully completing a geometric shape (e.g., row, column, 3×3 grid, etc.) of successful indicators, not only awarding their value but replacing them with new indicators. Or, for example, a specially denoted indicator with an “earthquake” award may nudge/shake neighboring indicators to be successful if not already so, thereby causing the award of their awards, and replace them with new indicators prior to the next spin. Or, a specially denoted indicator with a “black hole” award may sweep in all current successful indicators and replace them prior to the next spin. In one embodiment, this may lead to a “chain reaction” if, for example, a successful “earthquake” award causes, in turn, a successful “bomb” or doubler to occur. In one embodiment, if all indicators are successful, the game is retriggered, possibly with a new set of active indicators with higher award values.

The hold and respin teaching can be utilized with any base game (mechanical reels, video reels, video poker, etc.) as a bonus.

In a slot machine embodiment, base game triggers/symbols, upon landing, may themselves utilize an indicator. For example, potential trigger symbols comprising indicators, upon landing or upon the conclusion of a spin, may animate to determine if each symbol results in a successful trigger. Multiple successful triggers may be required, by the rules of the game, to initiate a bonus game. In the case of a hold and respin bonus, the successful triggers and/or their awards may carry-over into the bonus game. Too, within a base game, one or more special symbols, utilizing indicators as taught herein, may themselves determine if any award is successfully awarded.

In one embodiment, the expected value from the player choosing each initial indicator is the same. For example, consider two initial indicators, although three or more initial indicators may be utilized under this teaching. If the two initial indicators are (1) 10% chance of winning 1,000 credits and (2) 100% chance of winning 100 credits, the expected values are the same. That is, 10%×1,000=100%×100. In this way and via this method, the player's choice doesn't affect the expected value, but the player's choice affects volatility. Hence the game accommodates players with varying risk tolerances. Some players with a high risk tolerance may prefer a small chance at a big award, and others with a lower risk tolerance may prefer a large chance at a small award. The methodology taught herein affords each player to determine the level of volatility for the game as desired.

In another embodiment, the expected values for each initial indicator are not the same, and the game may be offered with expected values that are similar or widely different. In this embodiment, the player's choice directly affects the expected value. This allows for an element of strategy for the player in order to make the optimal decision that maximizes expected value.

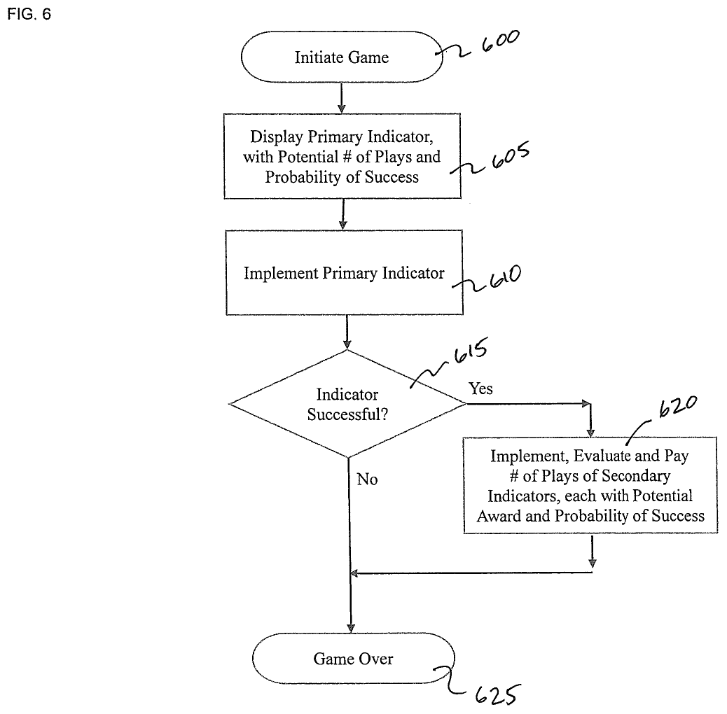

In one embodiment, shown in FIG. 6, upon game initiation, a primary indicator is displayed, with said indicator indicating a potential # of plays and probability of success. Either automatically or upon player input, the indicator is implemented (e.g., via animation) and resolved as either successful or a failure. If successful, the processor, via the instruction set in memory, further implements a number of secondary indicators equal to the # of plays, each with a potential award and probability of success. It then implements each of the secondary indicators, evaluates each secondary indicator's success or failure utilizing an RNG, and pays each successful secondary indicator.

In one embodiment, the primary indicator's chance of success and # plays are randomly drawn, via a RNG, from a table of probabilities for the chance of success and a separate table of probabilities for the # plays. In another embodiment, the primary indicator's chance of success and # play values are randomly drawn from one table of probabilities (comprising combinations of chance of success and # play values) as stored in memory. For the secondary indicators, the processor may similarly utilize one or more tables of probabilities, in conjunction with a RNG, to determine each secondary indicator's probability of success and award value. In one embodiment, the algorithm utilizes a dynamic method whereby the processor evaluates, e.g. the potential values and probabilities of success (the product of which is the expected value) of each secondary indicator, and ensures that at least one of the secondary indicator values exceeds the wager amount by increasing the potential value to exceed the wager, and correspondingly decreasing the probability of success, such that the expected value for said indicator remains the same. In one embodiment, the dynamic method ensures that at least one of the secondary indicator values has a probability of success that meets a minimum threshold (for example, 90% or 100%), with a corresponding increase of probability of success and decrease of potential award of any adjusted secondary indicator taking place algorithmically such that the expected value remains the same.

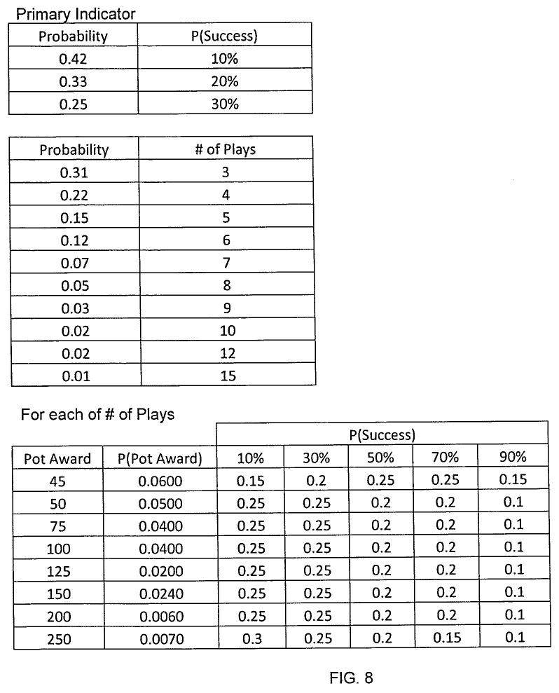

In FIG. 8, a portion of representative probability tables is shown, for a wager of 30 units. The primary (original) indicator's probability of success and potential # plays are first randomly selected, via an RNG, from weighted probability tables. For example, there is a 33% chance of P(success)=20%, and an independent 15% chance that the potential # Plays=5. If the primary indicator, upon implementation, is successful, the player is awarded the corresponding # Plays. The 5 Plays (each comprising a separate probability of success and award in credits) are then drawn from the subsequent weighted paytable. For example, 150 credits has a 2.4% chance of being randomly selected as the potential award for a given secondary indicator. The secondary indicator's probability of success is then randomly selected after selecting the potential award. For 150 credits as the potential award, the P(success) for the indicator has a 25% chance of being 10%, a 25% chance of being 30%, a 20% chance of being 50%, a 20% chance of being 70% and a 10% of being 90%. So once the potential award is selected, utilizing an RNG via a weighted probability table, the corresponding P(success) value is selected, utilizing an RNG via a weighted probability table associated with the potential award. So, for example, for a potential award of 150 credits, there is a 10% chance that P(success) will equal 90%. This same process is repeated for each of the secondary # Plays awarded. To the player, each secondary indicator may be played sequentially, simultaneously and/or with offsets as described herein.

Also in this embodiment, the player may be given a choice among a plurality of primary indicators, with the chosen indicator for example animating to success or failure, and values for the additional primary indicators derived, for example, via a dynamic algorithm as described herein to have equal, and as desired, similar or dissimilar, expected values.

In each embodiment described above, the use of bonus games and/or bonus plays is contemplated. Triggers for the bonus may appear in the primary indicator or secondary indicators. When triggered the bonus may comprise plays of the primary indicators, secondary indicators or both or special indicators.

In one embodiment of a bonus game, a set of indicators and awards is presented and executed to resolution of success or failure. The player is awarded the sum of all successes. Provided at least one, or a prescribed number, of indicators from the set are successful, the bonus retriggers a new set of indicators and awards, with the process continuing until zero (or less than the prescribed number) indicators are successful.

Various changes and modifications to the present disclosure and embodiments will be apparent to those skilled in the art, and such modifications may be made without departing from the spirit and scope of the invention. Variations described with respect to some embodiments are intended to be applicable to all other embodiments, unless specifically stated otherwise. The inventions described may be adapted for use in Class 2 (bingo-based) or pool (e.g., pull-ticket) environments. The use of “one” or “a” may include “one or more.”

I claim:

1. A gaming system comprising:
a processor;
a display device;
a payment device configured to receive monetary value from a player; and
a memory device storing instructions that, when executed, cause the processor to at least:
establish a credit balance responsive to receipt, by the payment device, of the monetary value from a player;
enable the player to place a wager on an indicator game, the wager deducted from the credit balance;
cause the display device to display an indicator game responsive to receipt of the wager and receipt of a game-initiation input, the indicator game configured to accept user-initiated inputs;
for the indicator game:
randomly determine a potential award based upon a first probability;
randomly determine probability of success of the percentage of the potential reward based upon a second probability;
awarding the percentage of the potential award based upon a user-initiated input;
cause the credit balance to increase for each percentage payout of the potential reward; and
initiate a cashout of the credit balance responsive to receipt of a cashout input.

2. A gaming system comprising:
a processor;
a display device;
a payment device configured to receive monetary value from a player; and
a memory device storing instructions that, when executed, cause the processor to at least:
establish a credit balance responsive to receipt, by the payment device, of the monetary value from a player;
enable the player to place a wager on an indicator game, the wager deducted from the credit balance;
cause the display device to display an indicator game responsive to receipt of the wager and receipt of a game-initiation input, the indicator game configured to accept user-initiated inputs;
for the indicator game:
using an RNG via a weighted probability table, randomly determine a potential award based upon a first probability;
using an RNG via a weighted probability table associated with the potential reward, randomly determine probability of success of the percentage of the potential reward based upon a second probability;
awarding the percentage of the potential award based upon a user-initiated input;
cause the credit balance to increase for each percentage payout of the potential reward; and
initiate a cashout of the credit balance responsive to receipt of a cashout input.
